(19) United States
(12) Patent Application Publication
(10) Pub. No.: US 2007/0250844 A1
(43) Pub. Date: Oct. 25, 2007

(54) Video Program Offer Generator

(75) Inventor: David A. Collacott, Sunnyvale, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/277,430

(22) Filed: Mar. 24, 2006

(51) Int. Cl. H04N 5/445; G06F 13/00; H04N 7/16

(52) U.S. Cl. 725/8; 725/58

(57) ABSTRACT

A procedure determines that program guide data in a program guide database has been updated. The procedure continues by retrieving data from the program guide database associated with at least some stations supported by a particular television service. Offer generation rules are applied to the data retrieved from the program guide database to generate a video program offer for each scheduled program event. Each video program offer is then stored in a subscriber database.

### BACKGROUND

New program guide information is made available by listings providers at regular intervals, such as once a day. The program guide information provides information about various programs, such as pay-per-view (PPV) programs and other television programs. The program guide information may also include information related to each of the various programs. For PPV programs, the program guide information may include the price and purchase window for each PPV program. The purchase window is the time period during which the PPV program can be purchased. An example purchase window extends from two hours before the PPV program is scheduled to begin until 30 minutes after the PPV program begins.

Program information is used by guide data servers (e.g., electronic program guide (EPG) databases) to provide program information to television viewers. To manage each video program offering, offer structures need to be generated for these programs and those offer structures need to be updated each time new program guide information is made available by listings providers. Listings data may not contain complete program information or the program information may be unreliable. Additionally, a particular service operator may want to override the pricing information contained in the listings data.

Editing or reviewing information associated with hundreds of video programs on a daily basis is tedious and error-prone. Therefore, it would be desirable to provide a system that is capable of automatically modifying received program information as desired by the service operator.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The systems and methods described herein determine that program guide data in a program guide database has been updated. In response to updated program guide data, these systems and methods identify stations that are supported by a particular television service and retrieve data from the program guide database that is associated with the stations supported by the particular television service. Offer generation rules are applied to the data retrieved from the program guide database to generate at least one video program offer, which is stored in a subscriber database.

The rules associated with the particular television service define prices for video programs, time periods when the price is discounted, a time window during which the video program can be purchased, the currency used to purchase the video program, and the like.

### BRIEF DESCRIPTION OF THE DRAWINGS

Similar reference numbers are used throughout the figures to reference like components and/or features.

FIG. 1 illustrates an example environment in which the systems and methods discussed herein can be applied.

FIG. 2 is a flow diagram illustrating an embodiment of a procedure for generating video program offers.

FIGS. 3A and 3B illustrate an example graphical user interface to add rules, delete rules, and edit rules.

FIG. 4 illustrates various components of an example client device in which the systems and methods discussed herein can be implemented.

FIG. 5 illustrates various devices and components in an example entertainment and information system in which the systems and methods discussed herein can be implemented.

### DETAILED DESCRIPTION

The systems and methods described herein automatically review and modify received video program information, such as pay-per-view (PPV) program information, by applying a set of configurable rules defined by the television service operator. Once the rules have been defined, the rules are applied automatically each time the program listings data is updated. Application of the rules occurs without intervention of the television service operator. For example, a particular television service operator may want all programs on channel PPV1 to have a price of $3.99, even though the listings data identifies a price of $4.99. By setting a pricing rule associated with channel PPV1, all programs available on channel PPV1 will be assigned a price of $3.99. The television service operator can define any number of rules to determine how prices and other program attributes are to be assigned.

Certain examples discussed herein are related to PPV programs. However, similar systems and methods may be used with any type of video program and with any parameter associated with any type of video program received from any source.

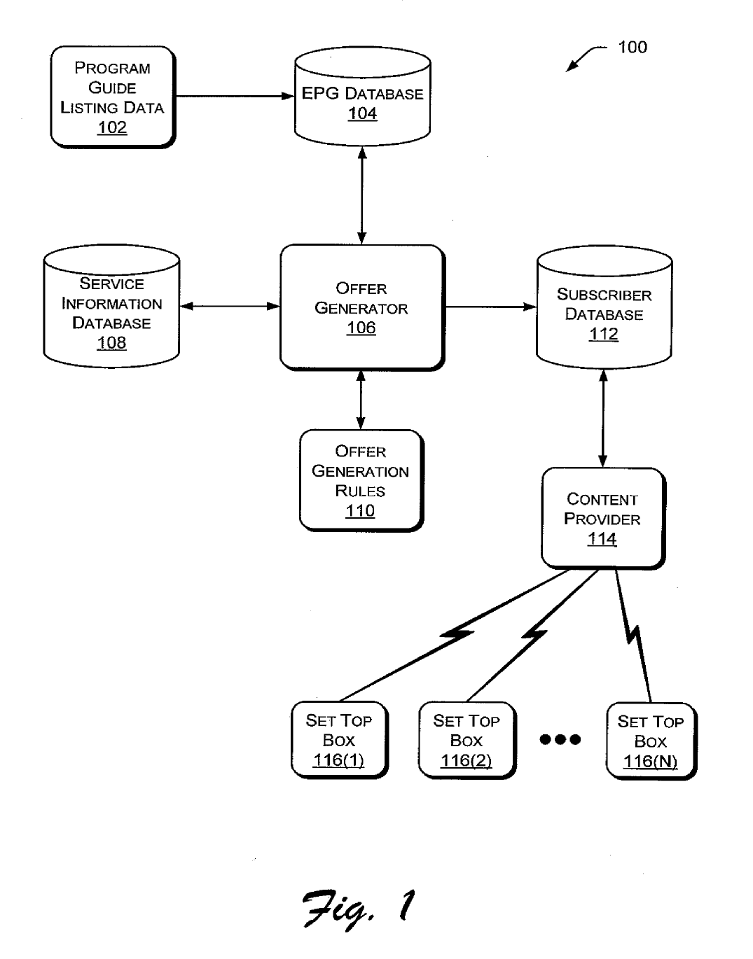

FIG. 1 illustrates an example environment 100 in which the systems and methods discussed herein can be applied. Program guide listing data 102 is provided by one or more guide listing services. Program guide listing data 102 includes program data associated with any number of different channels in any number of different geographic regions. The program data includes program descriptions, program start and end times, program rating, program price (e.g., for PPV programs), and the like. An electronic program guide (EPG) database 104 receives program guide listing data 102 and stores the data for access by other components.

An offer generator 106 accesses EPG database 104 to identify one or more video programs. Offer generator 106 also accesses information stored in a service information database 108, which is coupled to offer generator 106. Service information database 108 stores information regarding which channels are available on this particular system (e.g., this particular television service). Using the data in service information database 108 allows offer generator 106 to limit its operation to creating offers for programs available on this particular television service. Video program offers may contain various information, such as information about the program, the start time of the program, the duration of the program, the rating of the program, the cost of the program, and the like.

Offer generator 106 is also coupled to offer generation rules 110, which stores information regarding how offers should be generated for various video programs. These rules may, for example, set a particular price for a video program, regardless of whether any price information was received from EPG database 104. Other example rules discount the price of particular video programs during certain time periods or on certain days of the week. Other rules define the currency in which a video program is purchased, a window of time during which the video program can be purchased, and the like.

After receiving various data and applying any applicable rules, offer generator 106 generates one or more video program offers and communicates those offers to a subscriber database 112. Subscriber database 112 is accessible by a content provider 114, which is coupled to any number of set top boxes 116 or other client devices that are capable of receiving content from content provider 114. Thus, set top boxes 116 can access the content of subscriber database 112 via content provider 114.

Although FIG. 1 illustrates set top boxes 116 as example clients, any type of client may receive content from content provider 114. Other such clients include desktop computers, notebook computers, game consoles, handheld computers, personal digital assistants (PDAs), mobile phones, portable gaming devices, and the like.

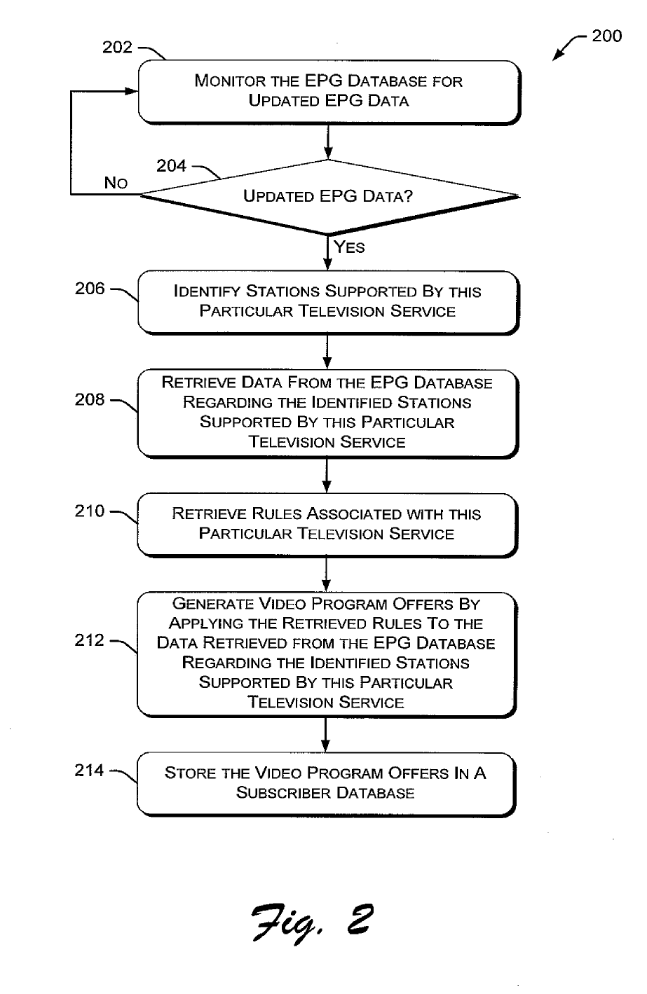

FIG. 2 is a flow diagram illustrating an embodiment of a procedure 200 for generating video program offers. In a particular implementation, procedure 200 is implemented by the system shown in FIG. 1. Initially, procedure 200 monitors an EPG database for updated EPG data (block 202). An EPG database may be updated, for example, once a day. If no updated EPG data is identified, the procedure continues monitoring the EPG database. When updated EPG data is identified, the procedure branches to block 206, which identifies stations supported by this particular television service. In an alternate embodiment, the identification of stations supported by the television service may not be performed every time updated EPG data is identified. For example, the supported stations may be identified once a day or once a week. If EPG data is updated two or three times in one day, the system may identify the supported stations once each day.

The procedure continues by retrieving data from the EPG database regarding the identified stations supported by this particular television service (block 208). Thus, the procedure does not retrieve data from the EPG database that is associated with stations that are not supported by this particular television service. Next, the procedure retrieves rules associated with this particular television service (block 210). Video program offers are generated by applying the retrieved rules to the data retrieved from the EPG database regarding the identified stations supported by this particular television service (block 212). In one embodiment, the video program offers are tied to events in the program guide. In this embodiment, if a particular station does not have an event listed in the program guide data, there are no video program offers generated for that station. Finally, the video program offers are stored in a subscriber database for access by one or more content providers (block 214).

As mentioned above, offer generation rules 110 (FIG. 1) define how video program offers should be generated for various video programs. Video program offers are data structures that define an offering for a particular scheduled video program. The information contained in a video program offer includes, for example, the station ID, price, currency, start and end times of the program, and the start and end of the purchase window. Since video program offers correlate with scheduled programs, they are created and updated at the same time new scheduled programs are added to the system. The video program offers are updated each time the EPG database is updated. This is necessary because video programs may change their schedules, prices can change, new schedules may be added, and old schedules may be removed.

Guide listings data is generally produced by a listings provider and not the television service operator. Thus, some video program data may be inaccurate or missing. The television service operator may want to edit (or add information to) the received video program data. The television service operator handles desired changes to the video program data by defining rules that are applied to the video program data. A particular system may have any number of rules. For example, a particular rule sets the given video program data field for the program during a time range on the particular station to the appropriate value. The parameters for this example rule are: data field to set, value to set, program ID (if empty, then apply to all programs), station ID (if empty, then apply to all stations), and time range (if empty, then apply to all times).

Another example rule sets the video program price for all schedules during the given time range on the given station to the particular value. The parameters for this example rule are: discount amount (negative values indicate a price increase), station ID (if empty, then apply to all stations), and time range (if empty, then apply to all times).

Another example rule adjusts the cents value of the program price for all programs scheduled during the given time range on the given station to a given value if it meets the given criteria. For example, this rule can be used to change all prices ending in 0.99 cents to end in 0.95 cents. The parameters for this example rule are: old cents value (if set to “−1”, then apply to all cents values), new cents value, station ID (if empty, then apply to all stations), and time range (if empty, then apply to all times).

Each rule also has a StartDateTime and an End DateTime indicating the range of dates over which the rule applies.

In an example embodiment, rules are defined using extensible markup language (XML) configuration files. The following is an example rule defined using an XML configuration file.

<ProgramRules>

<rule type = “set”>

<field>price</field>
<value>$1.99</value>
<ProgramID>921486</ProgramID>
<StationID>800394</StationID>
<start>10:00pm</start>
<end>3:00am</end>
<effective>2006-03-01</effective>
<expires>2006-04-01</expires>

</rule>

</ProgramRules>

The above rule sets the price of a video program having a ProgramID of 921468and a StationID of 800394 to a price of $1.99. This price is set for the video program regardless of the price associated with the video program in the EPG database. In this example, the specific price of $1.99 applies between 10:00 pm and 3:00 am. A different rule identifies the price of the video program at other times of the day. Additionally, this rule has an effective date of Mar. 1, 2006 and an expiration date of Apr. 1, 2006. Thus, the effective period of the rule is one month. After Apr. 1, 2006, the rule has no impact on the pricing of video programs (unless the rule is edited by a television service operator or other user). The ProgramID data identifies a specific video program to which this rule applies. The StationID data identifies a specific station to which this rule applies. The ProgramID data could be left empty to apply to all video programs and the StationID data could be left empty to apply to video programs from all stations.

Once the rules in a particular television service system are set, the rules are applied to the EPG data every time the EPG data in the EPG database is updated. When the offer generator applies the above rule to a video program that meets all of the rule's parameters, an offer is generated and stored in the subscriber database. The program offers stored in the subscriber database may change from one day to the next as the rules are edited (or as new rules are added) and as the data in the EPG database changes.

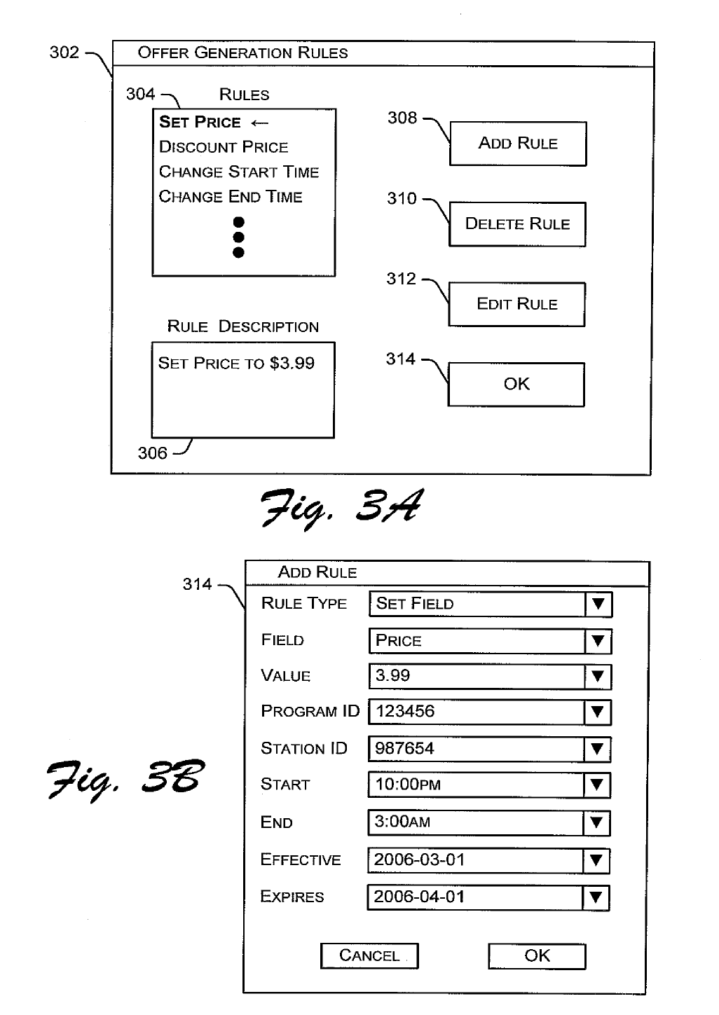

FIGS. 3A and 3B illustrate an example graphical user interface to add rules, delete rules, and edit rules. Referring to FIG. 3A, a graphical user interface screen 302 related to offer generation rules is shown. A rules block 304 in interface 302 displays various rules that have been created for the particular television service. In the example of FIG. 3A, the “Set Price” rule is highlighted (i.e., selected). A description of the “Set Price” rule is displayed in block 306. In this example, the “Set Price” rule is configured to set the price of a video program to $3.99.

An “Add Rule” block 308 allows a user (e.g., television service operator) to add a new rule and “Delete Rule” block 310 allows a user to delete an existing rule. Additionally, an “Edit Rule” block 312 allows a user to edit an existing rule and an “OK” 'block 314 returns the user to a previous interface screen (not shown). When a user activates “Add Rule” block 308, an “Add Rule” graphical user interface screen 314 is displayed (FIG. 3B). “Add Rule” interface screen 314 includes various rule parameters including a rule type, a field, a value, a program ID, a station ID, a start time, an end time, an effective date, and an expiration date. For each of these parameters, there is an associated value selected from a drop-down list of available options. In alternate embodiments, a user may enter values associated with one or more of the parameters displayed on interface screen 314. In other examples, one or more of the values associated with the parameters may be empty (e.g., null).

Although FIGS. 3A and 3B illustrate an example graphical user interface to add rules, delete rules, and edit rules, alternate embodiments may utilize any type of interface to add rules, delete rules, and edit rules. For example, a text-based user interface may be used to accomplish the same functions as the graphical user interface shown in FIGS. 3A and 3B.

The following example schema represents one possible collection of rules, names, parameters, values, and the like associated with the definition of one or more rules used to generate video program offers.

<rule> types:

“set”: set a program field to a given value

<field>: Name of field to set. Values: “price”, “currency”,

“purchase_window_start”, “purchase_window_end”

<value>: Value to set to field.
<overwrite>: Overwrite existing value: “true” overwrites

existing price from listings, “false” sets values only if absent from
listings

<program_id>: Program ID of program to set value. If

absent, then all programs are affected.

<station_id>: Station ID to apply to. If absent, then all

stations are affected.

<start_time>: Start time of time span to apply to.
<end_time>: End time of time span to apply to. If end time is

before start time, time span is considered to span midnight.
“discount”: lower program price by a given amount

<discount>: Amount to discount price by. If value is

negative, then price is increased.

<station_id>: Station ID to apply to. If absent, then all

stations are affected.

<start_time>: Start time of time span to apply to.
<end_time>: End time of time span to apply to. If end time is

before start time, time span is considered to span midnight.
“price_adjust”: change cents values of prices ending in old_cents to
new_cents

<old_cents>: old cents value of prices to apply rule to
<new_cents>: new cents value to change prices to
<station_id>: Station ID to apply to. If absent, then all

stations are affected.

<rule> effective/expiration: DateTime range indicating when to apply rule
<ProgramConfig>

<!-- set program prices for program 8004783 on station 19374 to
$1.99 between 8pm and 3am -->
<rule type=“set” effective=“2006-02-01 00:00” expiration=“2006-
03-01 00:00”>

| | |
|---|---|
| <field>price</field> | <!-- required --> |
| <value>1.99</value> | <!-- required --> |
| <overwrite>false</overwrite> | <!-- required --> |
| <program_id>8004783</program_id> | <!-- optional --> |
| <station_id>19374</station_id> | <!-- optional --> |
| <start_time>20:00</start_time> | <!-- optional --> |
| <end_time>3:00</end_time> | <!-- optional --> |

</rule>
<!-- set program currency to “US” for all programs on all stations -->
<rule type=“set” effective=“2006-02-01 00:00” expiration=“2006-
03-01 00:00”>

| | |
|---|---|
| <field>currency</field> | <!-- required --> |
| <value>US</field> | <!-- required --> |
| <overwrite>true</overwrite> | <!-- required --> |

</rule>
<!-- discount program prices for all programs on station 19374 by
$0.50 between 6pm and 11pm -->
<rule type=“discount” effective=“2006-02-01 00:00”
expiration=“2006-03-01 00:00”>

| | |
|---|---|
| <discount>0.50</discount> | <!-- required --> |
| <station_id>19374</station_id> | <!-- optional --> |
| <start_time>18:00</start_time> | <!-- optional --> |
| <end_time>23:00</end_time> | <!-- optional --> |

</rule>
<!-- change all prices ending in .99 to .95 on station 19374 -->
<rule type=“price_adjust” effective=“2006-02-01 00:00”
expiration=“2006-03-01 00:00”>

| | |
|---|---|
| <old_cents>99</old_cents> | <!-- required --> |
| <new_cents>95</new_cents> | <!-- required --> |
| <station_id>19374</station_id> | <!-- optional --> |

</rule>

</ProgramConfig>

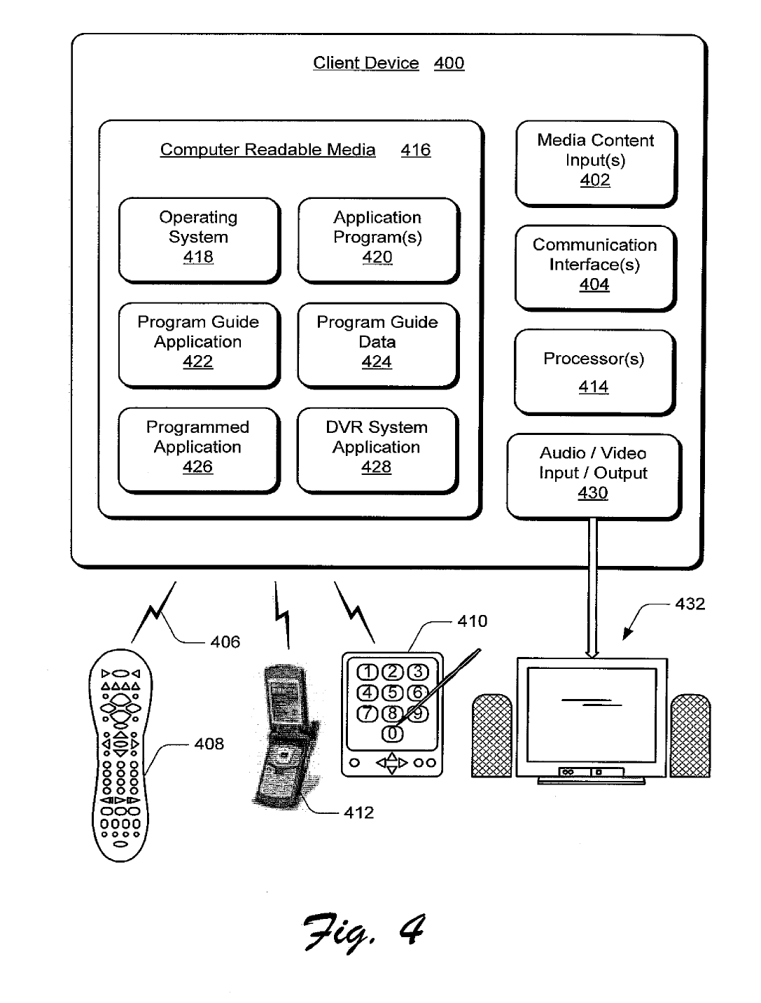

FIG. 4 illustrates various components of an exemplary client device 400 which can be implemented as any form of a computing, electronic, and/or television-based client device, and in which the systems and methods discussed herein can be implemented.

Client device 400 includes one or more media content inputs 402 which may include Internet Protocol (IP) inputs over which streams of media content are received via an IP-based network. Device 400 further includes communication interface(s) 404 which can be implemented as any one or more of a serial and/or parallel interface, a wireless interface, any type of network interface, a modem, and as any other type of communication interface. A wireless interface enables client device 400 to receive control input commands 406 and other information from an input device, such as from remote control device 408, PDA (personal digital assistant) 410, cellular phone 412, or from another infrared (IR), 802.11, Bluetooth, or similar RF input device.

A network interface provides a connection between the client device 400 and a communication network by which other electronic and computing devices can communicate data with device 400. Similarly, a serial and/or parallel interface provides for data communication directly between client device 400 and the other electronic or computing devices. A modem facilitates client device 400 communication with other electronic and computing devices via a conventional telephone line, a DSL connection, cable, and/or other type of connection.

Client device 400 also includes one or more processors 414 (e.g., any of microprocessors, controllers, and the like) which process various computer executable instructions to control the operation of device 400, to communicate with other electronic and computing devices, and to implement the embodiments described herein. Client device 400 can be implemented with computer readable media 416, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 416 provides data storage mechanisms to store various information and/or data such as software applications and any other types of information and data related to operational aspects of client device 400. For example, an operating system 418 and/or other application programs 420 can be maintained as software applications with the computer readable media 416 and executed on processor(s) 414 to implement the systems and methods discussed herein.

For example, client device 400 can be implemented to include a program guide application 422 that is implemented to process program guide data 424 and generate program guides for display which enable a user to navigate through an onscreen display and locate broadcast programs, recorded programs, video on-demand programs and movies, interactive game selections, network-based applications, and other media access information or content of interest to the user. The computer readable media 416 can also include a programmed application 426 to implement features and embodiments described herein. The computer readable media 416 can also include a DVR system application 428 to maintain and playback recorded media content.

Although the programmed application 426 is illustrated and described as a single application configured to implement embodiments described herein, the programmed application 426 can be implemented as several component applications distributed to each perform one or more functions in a client device in a television-based entertainment and information system. Further, the program guide application 422 may include the programmed application 426 as an integrated module or component.

The client device 400 also includes an audio and/or video output 430 that provides audio and video to an audio rendering and/or display system 432, or to other devices that process, display, and/or otherwise render audio, video, and display data. Video signals and audio signals can be communicated from device 400 to a television (or to other types of display devices) via an RF (radio frequency) link, S-video link, composite video link, component video link, analog audio connection, or other similar communication link.

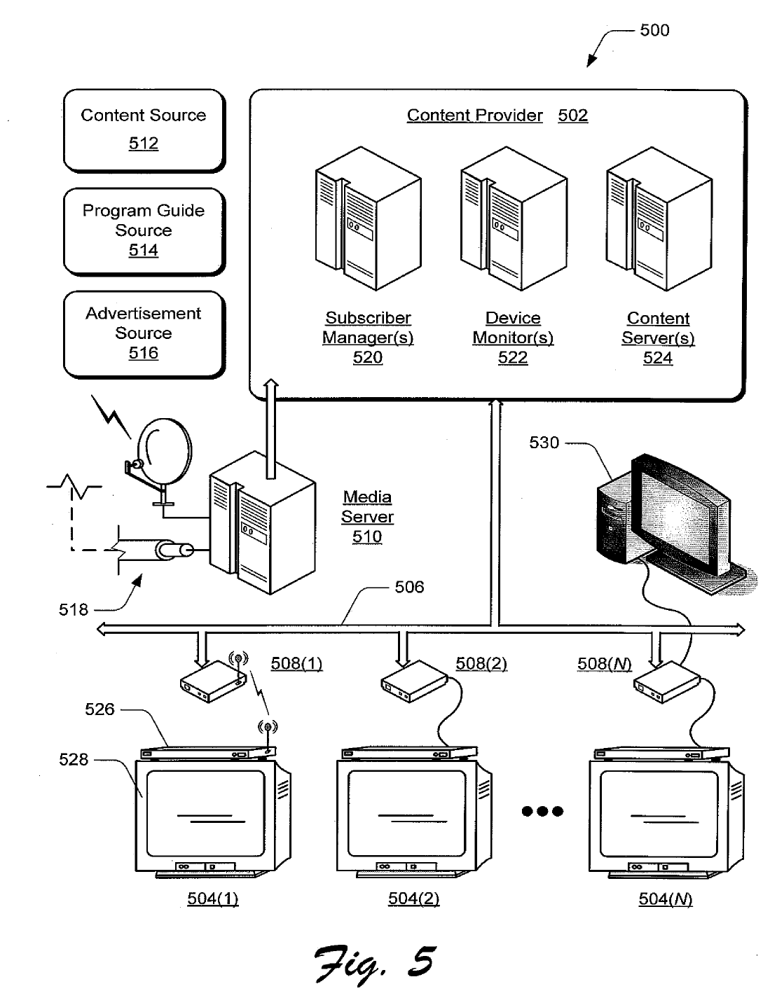

FIG. 5 illustrates an exemplary entertainment and information system 500 in which an IP-based television environment can be implemented, and in which embodiments discussed herein can be implemented. System 500 facilitates the distribution of program content, program guide data, and advertising content to multiple users. System 500 includes a content provider 502 and television-based client systems 504(1-N) each configured for communication via an IP-based network 506.

The network 506 can be implemented as a wide area network (e.g., the Internet), an intranet, a Digital Subscriber Line (DSL) network infrastructure, or as a point-to-point coupling infrastructure. Additionally, network 506 can be implemented using any type of network topology and any network communication protocol, and can be represented or otherwise implemented as a combination of two or more networks. A digital network can include various hardwired and/or wireless links 508(1-N), routers, gateways, and so on to facilitate communication between content provider 502 and the client systems 504(1-N). The television-based client systems 504(1-N) receive program content, program guide data, advertising content, closed captions data, and the like from content server(s) of the content provider 502 via the IP-based network 506.

System 500 includes a media server 510 that receives program content from a content source 512, program guide data from a program guide source 514, and advertising content from an advertisement source 516. In an embodiment, the media server 510 represents an acquisition server that receives the audio and video program content from content source 512, an EPG server that receives the program guide data from program guide source 514, and/or an advertising management server that receives the advertising content from the advertisement source 516.

The content source 512, the program guide source 514, and the advertisement source 516 control distribution of the program content, the program guide data, and the advertising content to the media server 510 and/or to other television-based servers. The program content, program guide data, and advertising content is distributed via various transmission media 518, such as satellite transmission, radio frequency transmission, cable transmission, and/or via any number of other wired or wireless transmission media. In this example, media server 510 is shown as an independent component of system 500 that communicates the program content, program guide data, and advertising content to content provider 502. In an alternate implementation, media server 510 can be implemented as a component of content provider 502.

Content provider 502 is representative of a headend service in a television-based content distribution system, for example, that provides the program content, program guide data, and advertising content to multiple subscribers (e.g., the television-based client systems 504(1-N)). The content provider 502 can be implemented as a satellite operator, a network television operator, a cable operator, and the like to control distribution of program and advertising content, such as movies, television programs, commercials, music, and other audio, video, and/or image content to the client systems 504(1-N).

Content provider 502 includes various components to facilitate media data processing and content distribution, such as a subscriber manager 520, a device monitor 522, and a content server 524. The subscriber manager 520 manages subscriber data, and the device monitor 522 monitors the client systems 504(1-N) (e.g., and the subscribers), and maintains monitored client state information.

Although the various managers, servers, and monitors of content provider 502 (to include the media server 510 in one embodiment) are illustrated and described as distributed, independent components of content provider 502, any one or more of the managers, servers, and monitors can be implemented together as a multi-functional component of content provider 502. Additionally, any one or more of the managers, servers, and monitors described with reference to system 500 can implement the features and embodiments discussed herein.

The television-based client systems 504(1-N) can be implemented to include a client device 526 and a display device 528 (e.g., a television). A client device 526 of a television-based client system 504 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 504(N) is implemented with a computing device 530 as well as a client device 526. Additionally, any of the client devices 526 of a client system 504 can implement the features and embodiments described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
determining that program guide data in a program guide database has been updated;
retrieving data from the program guide database associated with at least some stations supported by a particular television service;
applying offer generation rules to the data retrieved from the program guide database to generate at least one video program offer; and
storing the at least one video program offer in a subscriber database.

2. A method as recited in claim 1 wherein the rules associated with the particular television service include rules that define a price associated with video program offers.

3. A method as recited in claim 1 wherein the offer generation rules include rules that define a reduced price associated with video program offers and a time period during which the reduced price is effective.

4. A method as recited in claim 1 wherein the offer generation rules include rules that define a price associated with video program offers having a particular program identification.

5. A method as recited in claim 1 wherein the offer generation rules include rules that define a price associated with video program offers having a particular station identification.

6. A method as recited in claim 1 further comprising accessing the video program offer stored in the subscriber database by a content provider.

7. A method as recited in claim 1 further comprising accessing the video program offer stored in the subscriber database by a client device coupled to a content provider.

8. A method as recited in claim 1 further comprising applying the offer generation rules to future updated program guide data in the program guide database.

9. A method as recited in claim 1 further comprising identifying stations supported by a particular television service.

10. A method as recited in claim 9 wherein identifying stations supported by a particular television service includes identifying all pay-per-view stations supported by the particular television service.

11. A method as recited in claim 1 wherein the offer generation rules are associated with a particular television service.

12. A method comprising:
receiving program guide data from a program guide database;
identifying rules associated with video programs, including at least one rule that defines a price associated with at least one video program;
applying the identified rules to the data received from the program guide database to generate a video program offer for each scheduled program event in the program guide data;
storing each video program offer in a subscriber database; and
reapplying the identified rules to updated data received from the program guide database.

13. A method as recited in claim 12 further comprising allowing access to the subscriber database by a content provider.

14. A method as recited in claim 12 wherein the rules include a time period during which a price reduction on the cost of a particular video program is effective.

15. A method as recited in claim 12 wherein the rules define a time period during which a viewer may purchase a particular video program.

16. A method as recited in claim 12 wherein the rules define a currency in which a particular video program may be purchased.

17. An apparatus comprising:
a program guide database containing program data regarding a plurality of pay-per-view programs;
a service information database that contains information regarding which pay-per-view channels are available on a particular service;
a plurality of offer generation rules that define how offers should be generated for various pay-per-view programs; and
an offer generator coupled to the program guide database and the service information database, the offer generator coupled to receive the plurality of management rules, the offer generator to create pay-per-view offers by applying the plurality of offer generation rules to the program data contained in the program guide database.

18. An apparatus as recited in claim 17, further comprising a subscriber database coupled to the offer generator, wherein the subscriber database stores the created pay-per-view offers in the subscriber database.

19. An apparatus as recited in claim 17, wherein the plurality of offer generation rules include rules that define a price associated with pay-per-view offers.

20. An apparatus as recited in claim 17, wherein the plurality of offer generation rules include rules that define a period of time during which the pay-per-view offer is effective.
